(19) United States
(12) Patent Application Publication
(10) Pub. No.: US 2005/0205466 A1
(43) Pub. Date: Sep. 22, 2005

(54) Zn-containing FCC catalyst and use thereof for the reduction of sulfur in gasoline

(76) Inventors: Colin Lee Beswick, Middlesex, NJ (US); Barry Kevin Speronello, Montgomery, NJ (US); Joseph Bruce McLean, Kingwood, TX (US); Mark Robert Schmalfeld, Savannah, GA (US)

Correspondence Address: Gus Hampilos;Chief Patent Counsel, Engelhard Corporation, 101 Wood Ave., Iselin, NJ, 08830, US

(21) Appl. No.: 11/062,181

(22) Filed: Feb. 18, 2005

Related U.S. Application Data
(60) Provisional application No. 60/554,842, filed on Mar. 19, 2004.

(51) Int. Cl. C10G 11/05; B01J 29/06; B01J 29/08

(52) U.S. Cl. 208/120.01; 208/120.25; 502/64; 502/79

(57) ABSTRACT

Zeolite cracking catalyst compositions containing a zinc compound supported on silica-alumina are useful to process sulfur-containing hydrocarbon feedstocks. The compositions are especially useful for the production of reduced sulfur gasoline.

### RELATED APPLICATIONS

This Application is based on U.S. Provisional Application Ser. No. 60/554,842, filed Mar. 19, 2004.

### FIELD OF THE INVENTION

The present invention relates to catalytic cracking, and more specifically to catalytic cracking compositions and processes that may be used to catalytically convert high molecular weight feedstocks into valuable lower molecular weight products having reduced sulfur content.

### BACKGROUND OF THE INVENTION

It is generally known that catalytic cracking catalysts which comprise zeolites such as synthetic faujasite, zeolite Beta, and ZSM-5 dispersed in an inorganic oxide matrix such as silica/alumina may be used to economically convert heavy hydrocarbon feedstocks such as gas-oils and/or resid into gasoline and diesel fuel.

Environmental concerns have resulted in legislation limiting the sulfur content in fuels such as gasoline and diesel. Sulfur, when present in gasoline, not only contributes to SOx-emissions, but also poisons car engine exhaust catalysts. One way of reducing these sulfur levels is pretreating the hydrocarbon feed such as hydrotreating prior to catalytic cracking. However, such a process requires substantial capital investments and operating costs. It would be more desirable to reduce the sulfur content in situ, i.e., during processing in the FCC unit.

More recently it has been disclosed that the addition of SOx reduction “additives” such as alumina and magnesium aluminate (spinel) to cracking catalyst compositions will improve the overall performance of zeolite catalyst, particularly when used to process feedstocks that contain significant quantities of sulfur.

Canadian Patent No. 1,117,511 describes FCC catalysts which contain free alumina hydrate, particularly alpha-alumina hydrate (boehmite) which may be used to catalytically crack hydrocarbons that contain sulfur.

U.S. Pat. No. 4,010,116 discloses FCC catalysts which contain pseudo-boehmite aluminas that may contain crystalline trihydrate components such as bayerite and gibbsite.

While it is recognized that additives including aluminas and spinels may be added to catalytic cracking catalysts to reduce SOx emissions during the oxidation and regeneration of FCC catalyst, it has been discovered that additives to the catalytic cracking catalyst can reduce the sulfur level of cracked products such as gasoline and diesel fuel. An overview of such additives including Zn/hydrotalcite, ZrO/alumina, Zn/titania and Mn/alumina is provided in “Cracking Catalyst Additives for Sulfur Removal from FCC Gasoline,” in Catalysis Today, 53 (1999) 565-573.

U.S. Pat. No. 6,497,811 to T. Myrstad et al. also discloses such an in situ process for sulfur removal using a composition comprising a hydrotalcite material impregnated with a metal additive, i.e., a Lewis acid, preferably Zn. According to this document, the impregnated hydrotalcite material can be incorporated into the matrix of an FCC catalyst, or can be used as a separate compound next to an FCC catalyst.

WO 2004/002620 provides a catalyst composition comprising 5-55 wt. % metal-doped anionic clay, 10-50 wt. % zeolite, 5-40 wt. % matrix alumina, 0-10 wt. % silica, 0-10 wt. % of other ingredients, and balance kaolin, wherein the anionic clay is doped with at least one compound containing an element selected from the group of Zn, Fe, V, Cu, W, Mo, Co, Nb, Ni, Cr, Ce, and La. The term “metal-doped anionic clay” refers to an anionic clay not containing a binder material, which anionic clay has been formed in the presence of the dopant. The anionic clay is prepared by (a) aging an aqueous suspension comprising a divalent metal source and a trivalent metal source, at least one of them being water-insoluble, to form an anionic clay, and optionally (b) thermally treating the anionic clay obtained from step (a) and rehydrating the thermally treated anionic clay to form an anionic clay again. Anionic clays have a crystal structure which consists of positively charged layers built up of specific combinations of divalent and trivalent metal hydroxides between which there are anions and water molecules. Hydrotalcite is an example of naturally occurring anionic clay wherein Mg is the divalent metal, Al is the trivalent metal, and carbonate is the predominant anion present. Meixnerite is an anionic clay wherein Mg is the divalent metal, Al is the trivalent metal, and hydroxyl is the predominant anion present.

U.S. Pat. No. 5,525,210 discloses zeolite catalytic cracking catalyst compositions and additives that contain a Lewis acid supported on alumina and the use thereof to process hydrocarbon feedstocks. Specifically, cracking catalyst compositions are disclosed which contain from about 1 to 50 weight percent of a Lewis acid such as a compound of Ni, Cu, Zn, Ag, Cd, In, Sn, Hg, TI, Pb, Vi, B, Al (other than Al₂O₃), and Ga supported on alumina and that may be used to obtain gasoline fractions that have low sulfur content. In particular, a composition is disclosed which comprises from about 1 to 50 weight percent of a Lewis acid supported on alumina added to conventional particulate zeolite containing fluid catalytic cracking (FCC) catalysts as either an integral catalyst matrix component or as a separate particulate additive having the same particle size as the conventional FCC catalyst. The catalysts may be used in the catalytic cracking of high molecular weight sulfur-containing hydrocarbon feedstocks such as gas-oil, residual oil fractions and mixtures thereof to produce products such as gasoline and diesel fuel that have significantly reduced sulfur content. Importantly, U.S. Pat. No. 5,525,210 states that silica, which is also known to stabilize the surface area of alumina, is detrimental to the invention as disclosed therein.

### SUMMARY OF THE INVENTION

It as now been discovered, contrary to the disclosure of U.S. Pat. No. 5,525,210, that a zinc-containing FCC cracking catalyst containing a zeolite within a matrix which contains silica and wherein the zinc is primarily incorporated and carried by the matrix, can be used to crack hydrocarbons and produce a cracked product, such as gasoline and diesel fuel, which has a reduced sulfur level. The present inventors have found contrary to what was shown in U.S. Pat. No. 5,525,210, that zinc, such as in the form of zinc oxide, supported on a silica-alumina matrix was able to reduce the sulfur level of the cracked gasoline product during FCC catalytic cracking in the presence of a zeolite catalyst.

It is therefore an object of the invention to provide improved FCC catalysts and additives which possess the ability to reduce the sulfur content of cracked products.

It is another object of the present invention to provide improved catalytic cracking compositions, additives, and processes for converting sulfur-containing hydrocarbon feedstocks to low sulfur gasoline and diesel fuel.

It is yet a further object to provide a particulate FCC catalyst additive composition that may be blended with conventional zeolite-containing catalysts to reduce the sulfur content of cracked products.

These and additional objects of the invention will become readily apparent to one skilled in the art from the following detailed description of the invention.

### DETAILED DESCRIPTION OF THE INVENTION

Broadly, the present invention contemplates zeolite catalytic cracking compositions which contain zinc supported on a silica-alumina carrier and the use thereof to process hydrocarbon feedstocks.

More specifically, it has been discovered that cracking catalyst compositions which contain from about 0.1 to 50 wt. % (as zinc) of a zinc compound supported on silica-alumina is effective to obtain gasoline fractions that have a low sulfur content.

In particular, it has been found that if a composition which comprises from 0.1 to 50 wt. % (as zinc) of a zinc compound supported on silica-alumina is added to conventional particulate zeolite containing fluid catalytic cracking (FCC) catalysts as an integral catalyst matrix component, the catalyst may be used in the catalytic cracking of high molecular weight sulfur containing hydrocarbon feedstocks such as gas oil, residual oil, fractions and mixtures thereof to produce products such as gasoline and diesel fuel that have significantly reduced sulfur content. The compositions of this invention containing zeolite and zinc supported on a silica-alumina matrix can produce a gasoline fraction of reduced sulfur content even at high conversion of the feedstock.

While the mechanism by which the zinc-containing silica-alumina removes the sulfur components normally present in cracked hydrocarbon products is not precisely understood, it is surprising that reduction in sulfur content has been seen in view of the statements and examples in U.S. Pat. No. 5,525,210, which found that silica contained in the carrier to hold the Lewis acid did not reduce the sulfur content, especially at high conversion rates. On the contrary, applicants have found significant reductions in sulfur in the gasoline fraction at conversion rates above 65%.

The present desulfurization compositions are prepared by impregnating an FCC catalyst comprising in-situ formed zeolite contained within a silica-alumina matrix derived from calcined kaolin with a solution of a zinc salt. Typically, aqueous solutions which contain from about 10 to 20 weight percent of the zinc salt, such as the nitrates, chlorides and sulfates, or organic ester salts such as acetates, are used to impregnate the FCC catalyst to incipient wetness, i.e. fill the water pore volume. While a small amount of the zinc may be exchanged onto the zeolite, it is believed most, if not all, of the zinc salt is impregnated into the silica-alumina matrix of the FCC catalyst.

The zinc-impregnated FCC catalyst is then dried at 100° to 150° C. and heated (calcined) at 400° to 700° C., preferably 500-600° C., to remove the anionic component, such as chloride, nitrate, sulfate, or ester thereby yielding a particulate desulfurization composition which may be used alone or added to a commercial zeolite-containing “cracking” catalyst circulating inventory as a separate particulate additive. The additive of this invention will contain a zinc compound carried on the silica-alumina matrix in amounts of 0.1-50 wt. % Zn, typically 1-20 wt. % Zn, or 4-12 wt. % Zn, for example. The zinc compound formed will depend on the calcination conditions. Typically zinc oxide will be formed upon calcination to remove the anionic component of the zinc salt that is initially impregnated into the matrix. Other zinc compounds can be formed including zinc hydroxide, mixed oxides of zinc and aluminum, or zinc and remnants of the anionic component of the zinc salt.

The hydrothermal stability of matrix can be improved by stabilizing the silica-alumina with approximately 2 to 30 weight percent La₂O₃ or Ce₂O₃. This can be achieved by incipient-wetness impregnation of the FCC catalyst with an aqueous solution of lanthanum or lanthanum-rich rare earth salt solution, or similar cerium salt solutions followed by drying and calcination.

The FCC catalyst which contains the zinc component can be formed by known in-situ processes developed by Engelhard Corporation. For instance, U.S. Pat. No. 3,932,968 and U.S. Pat. No. 4,493,902, the entire contents of which are herein incorporated by reference, are examples of such a process. A catalyst in accordance with this invention can be obtained by (a) crystallizing at least 5% by weight Y-faujasite zeolite, under conditions that will be described below, in microspheres derived from a mixture of metakaolin and kaolin that has been calcined at least substantially through its characteristic exotherm, and (b) ion exchanging the resulting microspheres to replace the sodium cations in the microspheres with more desirable cations by procedures described below.

Preferably, the microspheres in which the zeolite is crystallized comprise, before the crystallization reaction, about 20-70% by weight metakaolin and about 30-80% by weight kaolin that has been calcined at least substantially through its characteristic exotherm to a silica-alumina structure. The microspheres may contain up to about 10% by weight of hydrous kaolin.

The preferred process for making the microspheres of calcined kaolin comprises a series of steps. First, finely divided hydrous kaolin (e.g., ASP® 600, a commercially available hydrous kaolin described in Engelhard Technical Bulletin No TI-1004, entitled “Aluminum Silicate Pigments” (EC-1167)) is calcined at least substantially through its characteristic exotherm. For example, a one inch bed of the hydrous kaolin may be calcined for about 1-2 hours in a muffle furnace at a chamber temperature of about 1800°-1900° F. to produce kaolin that has been calcined through its characteristic exotherm without any substantial formation of mullite. As another example, a substantial portion of the hydrous kaolin may be calcined through its characteristic exotherm into mullite by calcining a one-inch bed of the kaolin in an electrically heated furnace at a chamber temperature higher than about 2100° F.

During calcination, some of the finely divided kaolin agglomerates into larger particles. After completion of calcination, the agglomerated kaolin is pulverized into finely divided particles.

Next, an aqueous slurry of finely divided hydrous kaolin and the kaolin that has been calcined through its characteristic exotherm is prepared. The aqueous slurry is then spray dried to obtain microspheres comprising a mixture of hydrous kaolin and kaolin that has been calcined at least substantially through its characteristic exotherm. Preferably, a small amount of sodium silicate is added to the aqueous slurry before it is spray dried. It is believed that during and after spray drying the sodium silicate functions as a binder between the kaolin particles.

A quantity (e.g., 3 to 30% by weight of the kaolin) of zeolite initiator is also preferably added to the aqueous slurry before it is spray dried. As used herein, the term “zeolite initiator” shall include any material containing silica and alumina that either allows a zeolite crystallization process that would not occur in the absence of the initiator or shortens significantly the zeolite crystallization process that would occur in the absence of the initiator. Such materials are also known a “zeolite seeds”. The zeolite initiator may or may not exhibit detectable crystallinity by x-ray diffraction.

Adding zeolite initiator to the aqueous slurry of mixed kaolin before it is spray dried into microspheres is referred to herein as “internal seeding.” Alternatively, zeolite initiator may be mixed with the kaolin microspheres after they are formed and before the commencement of the crystallization process, a technique which is referred to herein as “external seeding”.

After spray drying, the microspheres are calcined at a temperature and for a time (e.g., for 2 hours in a muffle furnace at a chamber temperature of about 1350° F.) sufficient to convert the hydrous kaolin in the microspheres to metakaolin. The resulting microspheres comprise a mixture of metakaolin and kaolin that has been calcined at least substantially through its characteristic exotherm in which the two types of calcined kaolin are present in the same microspheres. Preferably, the microspheres comprise about 20-70% by weight metakaolin and about 30-80% by weight kaolin that has been calcined through its characteristic exotherm.

In the process described above, the metakaolin and kaolin that has been calcined through its characteristic exotherm are present in the same microsphere. It should be understood, however, that the present invention, in a broader scope, encompasses deriving the nonzeolitic component of the microspheres from other sources of calcined kaolin. For example, we believe that the non-zeolitic component of microspheres comprising at least about 5% by weight Y-faujasite and having the activity, selectivity, hydrothermal stability and attrition resistance characteristics required can be derived from microspheres comprising a mixture of metakaolin and kaolin clay that has been calcined through its characteristic exotherm without any substantial formation of mullite in which the two types of calcined clay are in separate microspheres.

The separate microspheres of metakaolin and kaolin that has been calcined through its characteristic exotherm without any substantial formation of mullite may be made by techniques which are known in the art. For example, the metakaolin microspheres may be made by first spray drying an aqueous slurry of ASP® 600 hydrous kaolin and a small amount of a dispersant (e.g., tetrasodium pyrophosphate) to form microspheres of the hydrous kaolin and then calcining those microspheres under conditions to convert the hydrous kaolin at least substantially to metakaolin. The metakaolin microspheres may be internally seeded by adding a zeolite initiator to the aqueous slurry of ASP® 600 kaolin.

Y-faujasite is allowed to crystallize by mixing the calcined kaolin microspheres with the appropriate amounts of other constituents (including at least sodium silicate and water), as discussed in detail below, and then heating the resulting slurry to a temperature and for a time (e.g., to 200°-215° F. for 10-24 hours) sufficient to crystallize at least about 5% by weight Y-faujasite in the microspheres.

The calcined kaolin microspheres are mixed with one or more sources of sodium silicate and water to form a slurry. Zeolite initiator is also added from a source separate from the kaolin if it had not previously been added (e.g., by internal seeding). Preferably, the resulting slurry contains: (a) a molar ratio of Na₂O/SiO₂ in the solution phase of about 0.49-0.57; and (b) a weight ratio of SiO₂ in the solution phase to microspheres of calcined kaolin of about 1.0-1.7. If necessary, sodium hydroxide may be included in the slurry to adjust the Na₂O in the solution phase to an appropriate level. As used herein, the “solution phase” of the slurry shall include all the material added to the crystallization reactor (including any mixture containing zeolite initiator if the crystallization process is externally seeded), except the material constituting the calcined clay microspheres (including, e.g., any zeolite initiator incorporated into the microspheres by internal seeding).

The following molar and weight ratios of constituents added to the crystallization reactor have provided satisfactory results (unless otherwise indicated the ratios given are molar ratios).

| solution phase Na₂O/ | wt. Solution phase SiO₂/ |
|---|---|
| solution phase SiO₂ | wt. microspheres |
| 0.57 | 1.00 |
| 0.52 | 1.35 |
| 0.50 | 1.50 |
| 0.49 | 1.70 |

When the crystallization process is internally seeded with amorphous zeolite initiator, it is preferred that the molar ratio of H₂O to Na₂O in the solution phase be no less than about 23. The reason for this is that reducing the molar ratio of H₂O to Na₂O in the solution phase to below that level can cause the microspheres to powder during the crystallization process and can result in slower zeolite growth during that process.

The molar ratios of all the constituents present in the crystallization reactor at the commencement of the crystallization process typically are within the following ranges:

| Na₂O/SiO₂ | SiO₂/Al₂O₃ | H₂O/Na₂O |
|---|---|---|
| 0.30-0.60 | 5-13 | 20-35 |

The preferred weight ratio of water to calcined kaolin microspheres at the beginning of the crystallization process is about 4-12. In order to minimize the size of the crystallization reactor, we prefer to maximize the amount of calcined kaolin microspheres added to the reactor and to minimize the amount of water present during the crystallization process. However, as this is done, the crystalline unit cell size of the zeolite crystallized increases. The preferred ratio of water to microspheres is, therefore, a compromise between that which results in maximum solids content in the crystallization reactor and that which results in a minimum unit cell size of the zeolite.

Good crystallization was obtained when the constituents added to the crystallization reactor provided the following molar and weight ratios at the commencement of the crystallization process (unless otherwise indicated the ratios given are molar ratios):

| | | | wt. H₂O/ |
|---|---|---|---|
| Na₂O/SiO₂ | SiO₂/Al₂O₃ | H₂O/Na₂O | wt. microspheres |
| .390 | 7.90 | 22.0 | 4.9 |
| .362 | 5.65 | 27.3 | 4.5 |
| .576 | 12.7 | 30.4 | 11.3 |

The sodium silicate and sodium hydroxide reactants may be added to the crystallization reactor from a variety of sources. For example, the reactants may be provided as an aqueous mixture of N® Brand sodium silicate and sodium hydroxide. As another example, at least part of the sodium silicate may be provided by the mother liquor produced during the crystallization of another zeolite containing product. Such a concentrated mother liquor by-product typically might contain about 15.0% by weight Na₂O, 29% by weight SiO₂ and 0.1% by weight Al₂O₃.

After the crystallization process is terminated, the microspheres containing Y-faujasite are separated from at least a substantial portion of their mother liquor, e.g., by filtration. It may be desirable to wash the microspheres by contacting them with water either during or after the filtration step. The purpose of the washing step is to remove mother liquor that would otherwise be left entrained within the microspheres.

The microspheres contain Y-faujasite in the sodium form. In order to obtain a product acceptable catalytic properties, it is necessary to replace sodium cations in the microspheres with more desirable cations. This is accomplished by contacting the microspheres with solutions containing ammonium or rare earth cations or both. The ion exchange step or steps are preferably carried out so that the resulting catalyst contains at least about 2%, preferably at least about 7%, by weight REO and less than about 0.7%, most preferably less than about 0.3%, by weight Na₂O. After ion exchange, the microspheres are dried, preferably by flash drying, to obtain the microspheres of the present invention.

The hydrocarbon feedstocks that are used and cracked under FCC conditions in the presence of the Zn-containing catalyst of this invention typically contain from about 0.1 to 12.5 weight percent, and, typically, 0.4-7 weight percent sulfur. These feedstocks include gas-oils which have a boiling range of from about 340° to 565° C. as well as residual feedstocks and mixtures thereof.

The catalytic cracking process is conducted in conventional FCC units wherein reaction temperatures that range of from about 400° to 700° C. and regeneration temperatures from about 500° to 850° C. are utilized. The catalyst, i.e. inventory, is circulated through the unit in a continuous reaction/regeneration process during which the sulfur content of cracked gasoline and diesel fuel fraction is reduced by 5 to 100 percent. The zinc-containing catalyst of this invention is blended with a standard FCC catalyst at a level of 1-100 wt. %, preferably at a level of 5-30 wt. %, and more preferably in amounts of 10-20 wt. % of total inventory.

During the catalytic cracking of a sulfur-containing gas-oil at 500° to 550° C., sulfur species are produced in the gasoline boiling range from the cracking reaction. These species are thiophene, C₁ to C₄ alkylthiophenes, tetrahydrothiophene, and propyl to hexyl mercaptans, which all have boiling points in the gasoline range. These species are Lewis bases and can interact with the Zn-containing catalyst of this invention. One such interaction would be adsorption of the sulfur Lewis base species to the Zn-containing catalyst in the riser/reactor side of the FCCU. The adsorbed species on the Zn-containing catalyst could then be oxidized free of the sulfur Lewis base species in the regenerator side of the FCCU, enabling more sulfur species to be adsorbed in the riser/reactor side. Another interaction would be the adsorption of the sulfur Lewis base on the Zn-containing catalyst, followed by cracking reactions in the riser/reactor side of the FCCU. The most likely products from these reactions would be hydrogen sulfide and hydrocarbons free of sulfur.

Having described the basic aspects of the invention, the following examples are given to illustrate specific embodiments. The examples are for the purpose of illustration only, and are not to be so construed as to strictly limit the scope of the claims which are appended hereto to the limitations shown therein.

### EXAMPLE 1

This example illustrates the preparation of a Zn-containing catalyst in accordance with this invention.

95% by weight of kaolin microspheres which had been formed by spray drying an aqueous slurry of hydrous kaolin and then calcining the kaolin beyond the exotherm at 1800° F. to a silica-alumina spinel are mixed with 5% by weight of kaolin microspheres formed by spray drying an aqueous slurry of hydrous kaolin and then calcining the formed microspheres at 1350° F. to form metakaolin microspheres. The mixture of microspheres is then placed in an aqueous caustic solution containing sodium silicate and then heat treated at 100° F. for 6-12 hours. The heat treated microspheres are then treated to a temperature of 180° F. until the zeolite growth within the microsphere results in about 20 wt. % of the particle. The Y-zeolite-containing microsphere is then cation exchanged with ammonium nitrate and rare earth nitrate to remove sodium. The final rare earth content is roughly 2 wt. % based on the weight of the microsphere.

An aqueous solution of zinc sulfate was added to fill about 90% of the pore volume of 7 kilograms of the Y-zeolite-containing microspheres formed above. The material was dried and then calcined at 1100° F. in air. The zinc content of the catalyst was found to be 4.4 wt. %.

### EXAMPLE 2

The zinc-containing catalyst formed in Example 1 was blended at a level of 20 wt. % with a standard commercial cracking catalyst and deactivated using a standard protocol. The catalyst blend containing approximately 20 wt. % of the zinc-containing catalyst of Example 1 corresponds to about 0.88 wt. % zinc based on the entire blend. The blend was tested in a circulating pilot plant riser unit. The gasoline sulfur level was lowered by roughly 11% compared to the same commercial cracking catalyst without the additive of Example 1.

1. A catalyst for reducing the sulfur content of a cracked fraction of a sulfur-containing hydrocarbon feed comprising: a catalyst particle containing a zeolite and zinc supported on a silica-alumina matrix.

2. The catalyst of claim 1 wherein said zinc is in the form of a zinc compound.

3. The catalyst of claim 2 wherein said catalyst contains 0.1-50 wt. % Zn.

4. The catalyst of claim 2 wherein said catalyst contains 1-20 wt. % Zn.

5. The catalyst of claim 2 wherein said catalyst contains 4-12 wt. % Zn.

6. The catalyst of claim 1 wherein said zeolite is zeolite Y.

7. The catalyst of claim 6 wherein said zeolite Y is formed in situ from a calcined kaolin particle.

8. The catalyst of claim 6 wherein said zeolite Y comprises at least 5 wt. % of said particle.

9. The catalyst of claim 1 wherein said catalyst particle is mixed with an additional zeolite-containing FCC catalyst.

10. The catalyst of claim 9 wherein said catalyst particles comprise 1-30 wt. % of said mixture.

11. A method for the catalytic cracking of sulfur-containing hydrocarbons which comprises reacting a hydrocarbon feedstock in the presence of a circulating catalyst inventory containing an FCC catalyst and catalyst particles comprising a zeolite molecular sieve and zinc supported on silica-alumina, and recovering gasoline fractions having a reduced sulfur content.

12. The method of claim 11 wherein said feedstock contains from about 0.1 to 12.5 wt. % sulfur.

13. The method of claim 11 wherein said catalyst particles comprise 0.1-50 wt. % as zinc in the form of a zinc compound.

14. The method of claim 11 wherein said catalyst particles comprise 1-20 wt. % as zinc in the form of a zinc compound.

15. The method of claim 11 wherein said zeolite is zeolite Y.

16. The method of claim 15 wherein said zeolite Y has been formed in situ from a calcined kaolin particle.

17. The method of claim 15 wherein said zeolite Y is present in amounts of at least 5 wt. %.

18. The method of claim 11 wherein said catalyst particles are present in amounts of from 1-100 wt. % of the circulating catalyst inventory.

19. The method of claim 11 wherein said catalyst particles are present in amounts of from 5-30 wt. % of the circulating catalyst inventory.

20. The method of claim 11 wherein said catalyst particles are present in amounts of from 10-20 wt. % of the circulating catalyst inventory.
